(19) United States
(12) Patent Application Publication
(10) Pub. No.: US 2013/0078598 A1
(43) Pub. Date: Mar. 28, 2013

(54) FAMILY AND CHILD ACCOUNT SOCIAL NETWORKING

(71) Applicant: Maureen Dunne, San Francisco, CA (US)

(72) Inventor: Maureen Dunne, San Francisco, CA (US)

(73) Assignee: UQ, INC., San Francisco, CA (US)

(21) Appl. No.: 13/612,801

(22) Filed: Sep. 12, 2012

Related U.S. Application Data
(60) Provisional application No. 61/533,542, filed on Sep. 12, 2011.

(51) Int. Cl. G09B 19/00

(52) U.S. Cl. CPC G09B 19/00
USPC 434/128

(57) ABSTRACT

A system and method for a social network within a social network which allows for the creation of a child network fully embedded within a parent/family network and the ability to ‘clone’ the child network so that parents can safely monitor their children while enjoying the adult features of the system or Internet. Also disclosed is an innovative method for combining story branching technology with user generated content to create a game-based social networking platform together with a story personalization method that enables characters to alter story structure by making choices at key decision points and to customize their gaming experience to their unique social network. Backend databases allow for the personalization and segmentation of data that remembers user choices, responses and experience to establish advanced recommendation systems unique to the goals of the individuals and their social network.

### PRIORITY

This application claims the benefit of provisional application No. 61/533,542, entitled “______” by the same inventors, filed on Sep. 12, 2011 which is incorporated by reference as if fully set forth herein.

### BACKGROUND

There are already conventional Internet locations and software programs designed specifically to promote a safe online environment for child. The sites typically include information such as Internet safety tips, educational quizzes and tutoring chat rooms where students can receive help with homework. However, they are all deficient in at least one respect in that they do not provide a complete safe environment.

Filtering software programs such as Cyber Patrol, Net Nanny and SmartFilter attempt to reduce the need for adult supervision. These programs can be installed onto a computer and serve to monitor, warn, or block access to web sites containing material which is inappropriate. Similar controls have been incorporated into some web browsers, including Internet Explorer and Netscape. These filtering software programs, however, often require that their settings must be modified frequently, because standard program settings may restrict access to sites which are appropriate for children and may not block out every inappropriate destination. Also, these digital filtering techniques do not provide children with an isolated interface within which they can communicate with another person who is guaranteed to be a safe resource.

However, none of these products provide an interface which allows children to communicate directly with another child or family group where each person the child contacts is pre-approved and all contact is continuously monitored.

### SUMMARY

Disclosed herein are systems and methods for a private, safe, networked environment for people to interact. In particular this disclosure provides for a parent creating a controlled environment for a child that only allows access to predetermined users and limits the availability of resources to the controlled environment.

The system and method for a social network within a social network which allows for the creation of a child network fully embedded within a parent/family network and the ability to ‘clone’ the child network so that parents can safely monitor their children while enjoying the adult features of the system or Internet. Also disclosed is an innovative method for combining story branching technology with user generated content to create a game-based social networking platform together with a story personalization method that enables characters to alter story structure by making choices at key decision points and to customize their gaming experience to their unique social network. Backend databases allow for the personalization and segmentation of data that remembers user choices, responses and experience to establish advanced recommendation systems unique to the goals of the individuals and their social network.

This disclosure may provide benefits for such things as child development, therapy and education. For example and without limitation, an educator may watch the child's interactions with other users to gauge their response to certain training methodologies or a therapist may clone a child's behavior to effect improvements in social interactivity. A therapist may also create game scenarios specifically to teach or coach a child towards acceptable decision making and behavior.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system that may be employed for some embodiments according to the current disclosure.

FIG. 2 illustrates one embodiment of a social networking structure according to the current disclosure.

FIG. 3 shows a flow chart including steps which may be employed for embodiments using game-base social networking.

### DESCRIPTION

The present disclosure relates to a new game-based social networking platform that allows users to create interactive stories with themselves, family and friends. Disclosed herein is a safe and secure child social network site with special features that are currently non-existent. In particular, there is a cloning synchronization technology feature in which parents and extended family members can view the child's activity and participate in real time for the purpose of behavioral management and encouraging optimal child development.

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “virtual machine” or “VM” generally refers to a self-contained operating environment that behaves as if it is a separate computer even though is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### Detailed Description

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

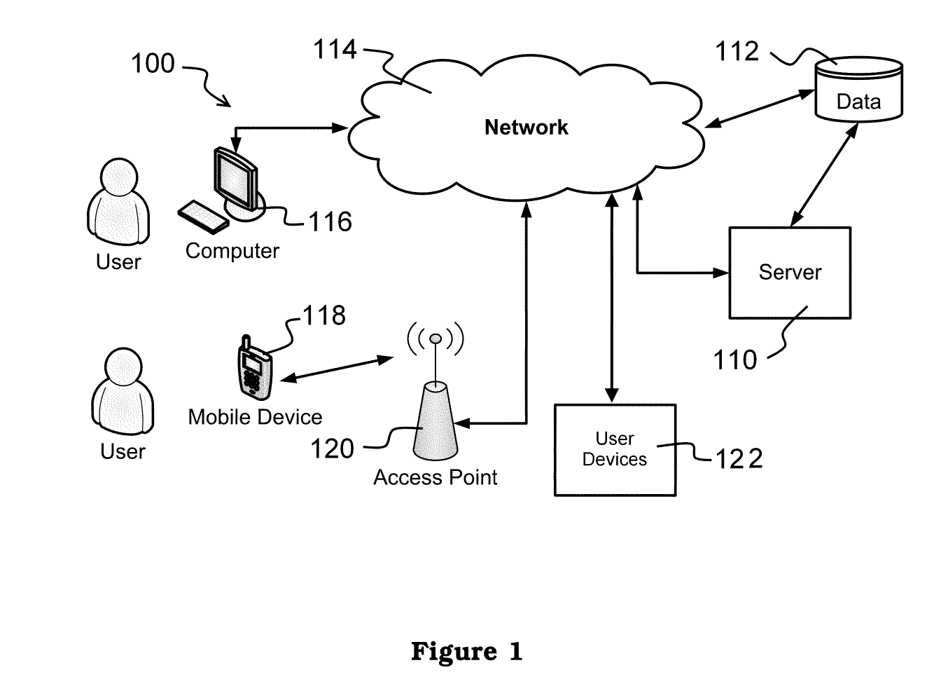

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Social Network

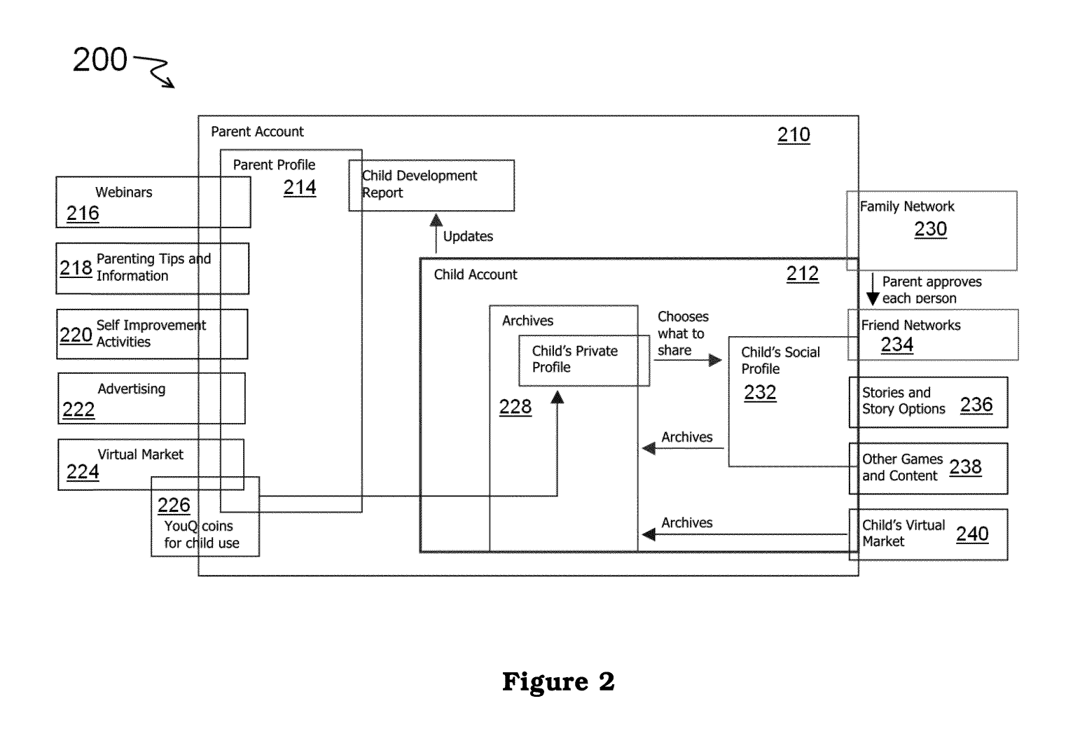

FIG. 2 illustrates one embodiment of a social networking structure 200 according to the current disclosure. The structure 200 illustrates the various functional components which may be included in some embodiments. For example and without limitation, there may be two accounts—a Parent/Family account 210 that may include all members of the family and individual child accounts 212. The relationship between the Parent account 210 and the child account 212 is a social network within a Parent/Family network wherein the parent account 210 operates to control the child account 212. In this embodiment the child can access individually the child account 212 with the child account 212 embedded entirely within the parent account 210.

Different accounts provide for different networking activities. In FIG. 2 a parent may have a profile 214 which includes the ability to access specific network resources including but not limited to: webinars 216, parent tip information 218, self improvement activities 220, advertising 222, and a virtual market 224.

One having skill in the art will recognize that the parent profile 214 may be effectuated using standard programming tools as described herein including but not limited to software engines to provide the profile. In certain embodiments the Parent Profile 214 may exist in structured data such as a data base or XML file. HTML code injection or other notorious techniques may be employed to present to a user the authorized resources and to direct web requests to the appropriate resources.

In certain embodiments the parent account 210 can view a mirror image or clone of the child's account 212 in real time. By viewing the child account 212, the parent (or control) account 210 can view all the child account 212 connections, communications, images, and interactions with other users and, if permitted, the Internet at large. This has the effect of allowing a parent to actively monitor their child's activity, even when the child is not aware of the monitoring. One having skill in the art will appreciate that the Child Account 212 may exist as a structured data entity and be accessible for cloning using standard database and Internet coding techniques.

In some embodiments, the cloning may be incremental. For example and without limitation, certain settings may provide for more privacy. The user of a Parent Account 210 may flag certain activities for monitoring while leaving other activities unmonitored. This allows the parent to be more permissive with network activities for older children such as teenagers.

In certain embodiments the parent account 210 has access to everything on the child account 212, however, the child only has access to his/her own account. The child account 212 may include several unique functional components, including a safe search engine (not shown) that filters through the internet and returns only child appropriate content. The child account 212 may include archive storage 228 for saving their memories and recording their personal and family history. In some embodiments the Child Account 212 is closed and private. Parents must approve of each individual the child adds to his/her social network. For example and without limitation, a family network 230 may be coupled to the parent account 210. The parent could select members of the family network 230 for inclusion into the Child Account 212. Similarly, the Parent Account may let other Internet resources into the Child Account 212.

The Child Account 212 may include a social profile 232. The social profile 232 may include access to resources such as a friends network 234 comprised of friends and communication to those friends, a story option 236 as described herein, games and other content 238, and a virtual market 240 where the child may save and spend virtual money.

### Virtual Money

In some embodiments virtual money may be used to reward a child's behavior. For example and without limitation coins (sometimes referred to as “YouQ coins” or “Q coins”) 226 may be paid to the child for meeting certain goals and expectations such as winning a game or performing a chore. An account of the coins may be kept for the Child Account 212 and used in the virtual market 240. In addition, the coins may be traded among the child's friends and generally used as currency.

In some embodiments parents and children both have access to the youQ virtual economy which consists of Q coins. Parents and children can earn Q coins by participating in activities. Parents may also purchase Q coins for themselves or for their children as part of an ‘allowance’ system.

### Cloning

In some embodiments the child clone and parent/child synchronization feature can apply to various forms of interactive content, for example and without limitation a shared whiteboard for collaborative art and shared game play with a game engine built on top of a multiplayer server such as SmartFox and other commercially available online resources.

The shared whiteboard embodiment allows parents, teachers, relatives or other users permitted by the system (“Followers”) to watch a child draw on a digital whiteboard. As the child draws, the followers see the changes occur on their own screens in near real-time. The child's experience is in effect cloned. In some embodiments the followers can also draw on the shared whiteboard. All drawing by the child and each follower is visible on the child's and all followers' screens.

One having skill in the art will appreciated that cloning may be affected through the use of conventional programming techniques. For example and without limitation the whiteboard drawing may stored as a sequence of drawing commands, i.e., draw line (timestamp, color, positionStart, positionEnd), etc . . . that combined provide the information required to both clone the experience to the follower's screens, and to recreate or playback the child's experience along a timeline. This command stream is used in memory, and also stored as structured data on a server for future playback and for analysis of the child's actions. In certain embodiments the draw commands may be resolution independent vector graphics. As a child draws, draw commands are sent over the network to a server that in turn sends the draw commands to each follower. As each follower draws, the draw commands are sent to the other followers and to the child. The draw commands are added to the player's list of draw commands which are in turn drawn to the player's whiteboard. A master list of commands may be stored on the child's device.

When a follower logs in and joins the group, the server requests the complete list of draw commands from the child in the group, then sends it to the newly logged in follower. This may form an initial synchronization step, and brings the command list for follower up to date with the child. This follower then receives only incremental updates of draw commands. Additionally, the system may allow each follower to recreate the child's experience, by playing back the creation of the drawing, with control similar to that used when watching a digital movie. The follower will have a variety of commands available such as Play, Play Slow, Play Fast, Pause, Rewind, Fast Forward, and jump directly to a point along the timeline. A follower can watch the actions the child took to create the drawing.

Additionally, the system may support the ability to save the drawing in an image format suitable for viewing on a website, such as PNG or JPG format. A system may also support the ability to save the drawing in a command stream format suitable for playback of the drawing experience. The actions the child took to create the drawing can be reloaded and played back at a later time.

The ability to clone a child's activity may provide benefits for such things as child development, therapy and education. For example and without limitation, an educator may watch the child's interactions with other users to gauge their response to certain training methodologies or a therapist may clone a child's behavior to effect improvements in social interactivity.

The attached Appendix A may include more details on certain embodiments and is included by reference as if fully set forth herein.

### Game-Based Social Networking

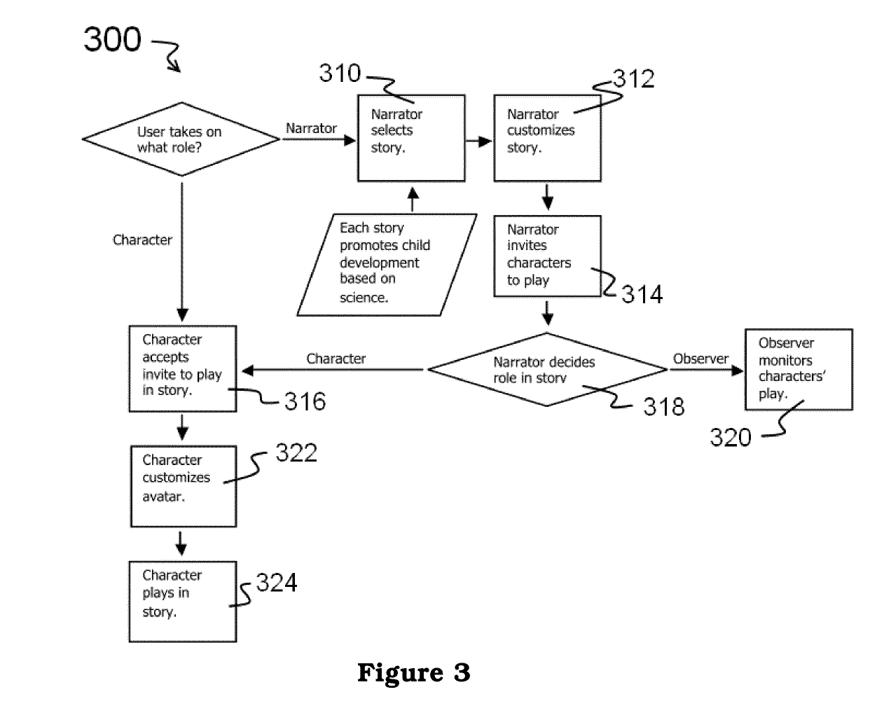

FIG. 3 shows a flow chart 300 including steps which may be employed for embodiments using game-base social networking. In FIG. 3 a user selects 310 an interactive story to create with his/her social network. Alternatively the user may customize a story 312. Story customization may include selecting specific story point choices (such as environment or story roles) and story activities (such as games and self discovery quizzes), as well as options like voice over narration, add photos or videos, etc. Each story alternative is designed to promote child development based on scientific research.

FIG. 3 represents an improvement upon existing story-based technology. Existing story-based software is simplistic in nature without the capacity for the system to adapt and alter the story structure based on both the decisions of both the main character as well as the other characters in the story. In the present case, the interactive story gaming engine is embedded within a social network. The main character or a ‘Designer’ customizes his avatar and invites friends and family within a private social network to join him in developing his story.

In FIG. 3 a ‘designer’ may be the main narrator of the story and invites members of their network 314 to participate by taking on the role of other characters in the story. In each story, the users get to select what role they will play by selecting a character and the players accept their roles 316. In certain embodiments, a narrator may join the story by selecting a role 318, or an observer may monitor the character's play 320.

In operation, the characters may be represented by an avatar which allows for certain amount of customization 322. Avatar customization may include selecting appearance (such as hair color and clothing), adding photos, uploading profile information (such as self discovery quiz results), etc. Customization items may be either earned through participation or through purchase including the use of virtual currency.

Each story structure contains ‘decision points’ whereby one or more characters must decide some action that determines the outcome of the story. Decision points may be considered as plot points within the story that can change depending on the choices of the characters. A character's choices in the story have impact. The user may be influenced by a narrator or other user at each decision point. Decisions affect the story structure, resulting in different experiences for different choices.

Game options do not influence the story outcome but give users the opportunity to personalize and improve their stories by setting different options for play. For example and without limitation, a character may customize their avatars and are able to update the clothing, environment and other story features by purchasing Q coins.

Certain embodiments may be used as part of therapy to help with empathy development for children. For example and without limitation, a user may set up games having different decisions points designed to test for certain decision making processes and skills. A second user, or group of users, may then watch the child's process, provide coaching information or messages to influence positive aspects of the child's behavior and reward the child using Q coins. The inventor contemplates multiple game scenarios other that those explicit in this disclosure and that therapists may construct game scenarios targeted towards specific conditions. This may be effectuated using differing amounts of decision points with varying complexity and group involvement.

The attached Appendices B and C may include more details and are incorporated by reference as if fully set forth herein.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A method comprising:
receiving, at a server, at least one game scenario, said game scenario including at least one decision point;
inviting a user to play the game;
monitoring the user's play;
coaching the user in response to said monitoring, and
altering the game scenario in response to the user's play.

2. The method of claim 1 wherein the coaching is provided by the monitor.

3. The method of claim 1 wherein the coaching is provided by a second player in the game.

4. The method of claim 1 wherein the game is part of a therapy.

5. The method of claim 4 wherein the coaching effects changes in the user's social interactivity.

6. The method of claim 1 further including:
customizing the game scenario to effect a therapeutic result.

7. The method of claim 1 wherein the game is imbedded in a private social network.

8. The method of claim 7 wherein the private social network is controlled by a designer, said designer controlling at least the network components, game scenarios and access to the private social network.

9. The method of claim 1 further including:
storing the game history on the server in a structured data format.

10. One or more processor readable storage devices having processor readable code embodied on said processor readable storage devices, said processor readable code for programming one or more processors to perform a method comprising:
receiving at least one game scenario, said game scenario including at least one decision point;
inviting a user to play the game;
monitoring the user's play;
coaching the user in response to said monitoring, and
altering the game scenario in response to the user's play.

11. The device of claim 10 wherein the coaching is provided by the monitor.

12. The method of claim 10 wherein the coaching is provided by a second player.

13. The method of claim 10 wherein the game is part of a therapy.

14. The method of claim 10 wherein the coaching effects changes in the user's social interactivity.

15. The method of claim 10 wherein the method further includes:
customizing the game scenario to effect a therapeutic result.

16. The method of claim 10 wherein the game is imbedded in a private social network.

17. The method of claim 16 wherein the private social network is controlled by a designer, said designer controlling at least the network components, game scenarios and access to the private social network.

18. The method of claim 10 wherein the method further includes:
storing the game history on the server in a structured data format.
